(19) United States
(12) Patent Application Publication
(10) Pub. No.: US 2026/0160882 A1
(43) Pub. Date: Jun. 11, 2026

(54) GESTURE DETECTION METHOD, INTENDED IN PARTICULAR FOR CONTROLLING A MOTOR VEHICLE OPENING ELEMENT

(71) Applicant: Vitesco Technologies GmbH, Regensburg (DE)

(72) Inventors: Wladia WASZAK, Toulouse (FR); Emilie CUMINAL, Toulouse (FR); Damien MESSAOUDI, Toulouse (FR)

(73) Assignee: Vitesco Technologies GmbH, Regensburg (DE)

(21) Appl. No.: 18/710,249

(22) PCT Filed: Nov. 25, 2022
(86) PCT No.: PCT/EP2022/083267

§ 371 Date: May 15, 2024

(30) Foreign Application Priority Data
Nov. 30, 2021 (FR) 2112751

(51) Int. Cl. G01S 13/88; E05F 15/73; G01S 7/285; G01S 13/62

(52) U.S. Cl. CPC G01S 13/88; E05F 15/73; G01S 7/285; G01S 13/62; E05Y 2900/531; E05Y 2900/548

(57) ABSTRACT

A gesture detection method implemented to control the opening of a motor vehicle opening element. The method using a return pulse signal resulting from the reflection of a transmitted pulse signal from a target, the return pulse signal and the transmitted pulse signal each consisting of radiofrequency pulses. The method includes: a) determining an approximate distance to the target, via measurement of a time offset between a pulse of the return pulse signal and the corresponding pulse of the transmitted pulse signal; b) determining an additional distance to the target, via monitoring of phase shift values between the return pulse signal and the transmitted pulse signal; c) combining the approximate distance to the target and the additional distance to the target, so as to obtain an estimated value of the distance to the target. Preferably, the gesture detection is used to control opening of a motor vehicle opening element.

### CROSS REFERENCE TO RELATED APPLICATIONS

This application is the U.S. National Phase Application of PCT International Application No. PCT/EP2022/083267, filed Nov. 25, 2022, which claims priority to French Patent Application No. 2112751, filed Nov. 30, 2021, the contents of such applications being incorporated by reference herein.

### FIELD OF THE INVENTION

The invention relates to a gesture detection method. Such a method is advantageously implemented for the purpose of controlling, using a predetermined gesture performed by a human operator, the opening of one or more opening elements of a motor vehicle, in particular the opening of the rear trunk or of a side door. The invention also covers a microcontroller, intended to be installed within a motor vehicle, and configured to implement the steps of the method according to the invention.

### BACKGROUND OF THE INVENTION

The prior art discloses various gesture detection methods based on the transmission and reception of radiofrequency signals for controlling the opening of a motor vehicle opening element.

Throughout the text, a radiofrequency signal denotes a frequency signal the frequency of the carrier of which is between 3 kHz and 300 GHz. Preferably, the frequency of the carrier in the invention is between 5 GHz and 20 GHZ, more preferably between 5 GHz and 10 GHz.

Known gesture detection methods are based on the transmission of a transmitted radiofrequency signal in the direction of a target, and the reception of a return radiofrequency signal that corresponds to the reflection of the transmitted radiofrequency signal from said target. The target is for example the foot of a user, performing a predetermined gesture.

It is also known in these methods to use a pulsed radiofrequency signal, consisting of what are referred to as radiofrequency pulses, that is to say pulses the carrier frequency of which belongs to the radiofrequency spectrum. Such methods may measure a time of flight, that is to say measure a time taken by a pulse to perform the round trip between a transceiver device and the target. The time of flight is related to the distance traveled by the pulse by c, the speed of light in a vacuum. The time of flight thus makes it possible to determine the distance between the target and the transceiver device.

In practice, the pulses of the return radiofrequency signal are detected on an amplitude signal that is temporally sampled by an analog-to-digital converter. The frequency of the temporal sampling defines sampling time windows, and therefore a precision on the time of flight measurement. In order to maximize this precision, the sampling frequency should be as high as possible. However, the Shannon criterion sets the maximum value of the sampling frequency at twice the highest frequency of the envelope of the received pulse signal, that is to say twice the highest frequency of the envelope of the transmitted pulse signal.

A typical value of the highest frequency of the envelope of the transmitted pulse signal is 500 MHz, this corresponding to a maximum value of the sampling frequency equal to f_{ech}=1 GHz. This corresponds to a margin of error Δd_{AR}=c/f_{ech} on the determination of the round-trip distance to the target, that is to say a margin of error Δd₁=c/2*f_{ech}=15 cm on the outward distance to the target.

### SUMMARY OF THE INVENTION

One aim of an aspect of the present invention is to propose a solution that makes it possible to determine a distance to the target with improved precision (that is to say a reduced margin of error) compared to the solutions from the prior art.

This aim is achieved with a gesture detection method, using a return pulse signal resulting from the reflection of a radiofrequency transmitted pulse signal from a target, the return pulse signal and the transmitted pulse signal each consisting of radiofrequency pulses, the method comprising the following steps:
a) determining an approximate distance to the target, implementing measurement of a time offset between a pulse of the return pulse signal and the corresponding pulse of the transmitted pulse signal;
b) determining an additional distance to the target, implementing monitoring of phase shift values between the return pulse signal and the transmitted pulse signal;
c) combining the approximate distance to the target and the additional distance to the target, so as to obtain an estimated value of distance to the target; and
d) repeating steps a) to c), so as to obtain a series of estimated values of distance to the target, said series of values defining a gesture.

Said steps are advantageously implemented within a microcontroller.

The transmitted pulse signal is transmitted by a transceiver device, and received by the same transceiver device.

Throughout the text, a distance to the target denotes a distance between said target and the transceiver device.

Preferably, the gesture detection method is implemented in order to control opening of a motor vehicle opening element.

Step a) implements the determination of a difference between a time of reception, by the transceiver device, of a pulse of the return pulse signal, and a time of transmission, by the same transceiver device, of the corresponding pulse of the transmitted pulse signal. This therefore involves measuring a time of flight. Step a) makes it possible to obtain the value of an approximate distance to the target, with a margin of error Δd₁.

As explained in the introduction, the following applies:

$$Δ {d}_{1} = c / ( 2 * {f}_{1} ) , \qquad [ Math 1 ]$$

where c is the speed of light in a vacuum, and
f₁ is the highest frequency of the envelope of the transmitted pulse signal.

The highest frequency of the envelope of the transmitted pulse signal is for example around 500 MHz, that is to say a margin of error of 15 cm on the value of the approximate distance to the target.

Step b) uses monitoring of phase shift values between the return pulse signal and the transmitted pulse signal. Each phase shift value relates to the difference between the phase of a pulse of the return pulse signal, upon reception by the transceiver device, and the phase of the corresponding pulse of the transmitted pulse signal, as transmitted by the transceiver device. Each phase shift value preferably corresponds to the low-frequency component of said phase difference.

The value of the phase shift between the return pulse signal and the transmitted pulse signal varies by 2π, for each variation of λ₂ on the round-trip distance traveled by the pulse, where λ₂ is the wavelength of the pulses of the transmitted pulse signal.

Thus, each increment of 2π on the value of this phase shift corresponds to a variation of λ₂/2 on the outward distance between the transceiver device and the target.

By counting the increments of 2π on said phase shift value, variations of λ₂/2 on the distance to the target are therefore counted. The result of the count of these variations defines the value of the additional distance to the target.

The additional distance to the target therefore has a margin of error Δd₂ defined by:

$$Δ {d}_{2} = {λ}_{2} / 2 = c / ( 2 * {f}_{2} ) , \qquad [ Maths 2 ]$$

where c is the speed of light in a vacuum, and
f₂ is frequency of the carrier of the transmitted pulse signal.

The frequency f₂ of the carrier of the transmitted pulse signal is far greater than the maximum frequency f₁ of the envelope of the pulses, for example with a ratio greater than or equal to 10 between the two. Therefore, the margin of error in determining the additional distance to the target is far smaller than the margin of error in determining the approximate distance to the target, for example with a ratio of less than or equal to 0.1 between the two.

The additional distance to the target offers a reduced margin of error. One drawback, however, is that there is uncertainty regarding the point of origin starting from which the additional distance to the target is defined.

In step c), the additional distance to the target is combined with the approximate distance, so as to obtain an estimated value of distance to the target. Preferably, said combination is a sum. The advantages associated with each of these two values are thus combined, namely a known origin, by virtue of the approximate distance to the target, and a reduced margin of error, by virtue of the additional distance to the target. Said known origin corresponds to the location of the transceiver device.

Repeating steps a) to c) makes it possible to obtain a series of estimated values of distance to the target, defining a movement performed by the target.

Advantageously, the method according to an aspect of the invention furthermore comprises a step of transmitting the transmitted pulse signal, and a step of receiving the return pulse signal, these steps being implemented by a radiofrequency transceiver system provided with at least one radiofrequency antenna.

Preferably, step a) comprises identifying, on a temporally sampled amplitude signal, a sampling time window receiving a local maximum of said amplitude signal.

In step b), the phase shift values advantageously each consist of a low-frequency component of a phase shift between the return pulse signal and the transmitted pulse signal.

Preferably, in step b), the phase shift values each relate to a predetermined time belonging to a sampling time window identified in step a).

Advantageously, determining an additional distance to the target implements:
detection of at least one local maximum, on data relating to the monitoring of phase shift values between the return pulse signal and the transmitted pulse signal; and
when a new local maximum is detected, updating of a current value of the additional distance to the target, so as to vary it by an elementary target offset value.

Said updating may comprise determining a direction of movement of the target, so as to determine whether the updating consists in adding or subtracting the elementary target offset value.

Advantageously, determining the direction of movement of the target implements a search for the signal the phase of which leads that of the other, out of the return pulse signal mixed with the transmitted pulse signal or its carrier, and the return pulse signal mixed with the transmitted pulse signal phase-shifted by an angle of 90° or its carrier phase-shifted by an angle of 90°.

Preferably, determining the additional distance to the target implements resetting of the current value of the additional distance to the target to the value zero when a variation in the time offset between a pulse of the return pulse signal and the corresponding pulse of the transmitted pulse signal was detected in step a).

Steps a) to c) are advantageously implemented by implementing the following steps, for each of a plurality of pulses of the transmitted pulse signal:
i) determining a time offset between said pulse of the transmitted pulse signal and the corresponding pulse of the return pulse signal, this time offset defining the value of the approximate distance to the target;
ii) comparing between the time offset determined in step i) and a reference time offset;
iii) when the time offset determined in step i) is different from the reference time offset, updating the value of the reference time offset so as to set it to the value determined in step i), and setting the additional distance to the target to the value zero;
iv) calculating a value of a phase shift between said pulse of the transmitted pulse signal and the corresponding pulse of the return pulse signal, and using said phase shift value to supplement phase shift value monitoring data;
v) searching for a new local maximum in said monitoring data;
vi) when a new local maximum is detected, determining a direction of movement of the target, and updating the value of the additional distance to the target so as to increase it or reduce it depending on the direction of movement of the target;
vii) summing the approximate distance to the target and the additional distance to the target, so as to obtain the estimated value of the distance to the target.

An aspect of the invention also covers a computer program product comprising instructions that, when the program is executed by a processor, cause said processor to implement the method according to an aspect of the invention.

An aspect of the invention also covers a microcontroller intended to be installed within a motor vehicle, the microcontroller comprising at least one processor and at least one memory, and the microcontroller being configured to implement the steps of the method according to an aspect of the invention. Said microcontroller is configured to receive, at input, data relating to the return pulse signal and data relating to the transmitted pulse signal, and the microcontroller is furthermore configured to deliver, at output, said series of estimated values of the distance to the target.

An aspect of the invention also relates to a motion detection system, configured to be installed in a motor vehicle, and comprising:
a transceiver device, configured to transmit said transmitted pulse signal and to receive said return pulse signal; and
a signal processing module, connected to the transceiver device, and comprising a microcontroller according to an aspect of the invention.

An aspect of the invention also relates to a motor vehicle equipped with such a motion detection system.

### BRIEF DESCRIPTION OF THE DRAWINGS

Other features and advantages of aspects of the invention will become more apparent upon reading the following description. This description is purely illustrative and should be read with reference to the appended drawings, in which:

FIG. 1A schematically illustrates a transmitted pulse signal and a return pulse signal, used in a method according to an aspect of the invention;

FIG. 1B schematically illustrates a pulse of the transmitted pulse signal;

FIG. 2A schematically illustrates a pulse of the return pulse signal, which pulse is sampled temporally;

FIG. 2B schematically illustrates a matrix grouping together values relating to a plurality of pulses;

FIG. 3 schematically illustrates a phase shift phenomenon used to determine the value of the additional distance to the target, in the method according to an aspect of the invention;

FIG. 4 schematically illustrates one advantageous embodiment of a method according to the invention;

FIG. 5 schematically illustrates monitoring of phase shift values implemented in the method of FIG. 4;

FIG. 6 schematically illustrates signals used in the method of FIG. 4, so as to determine a direction of movement of the target;

FIG. 7 schematically illustrates one example of a motion detection system according to an aspect of the invention; and

FIG. 8 schematically illustrates a vehicle equipped with a motion detection system according to an aspect of the invention.

### DETAILED DESCRIPTION OF AT LEAST ONE EMBODIMENT

An aspect of the invention relates to a gesture detection method, and uses:
data relating to a pulsed radiofrequency signal, transmitted by a transceiver device in the direction of a target; and
data relating to a return pulsed radiofrequency signal, received by the transceiver device, and corresponding to the reflection of the transmitted pulse signal from said target.

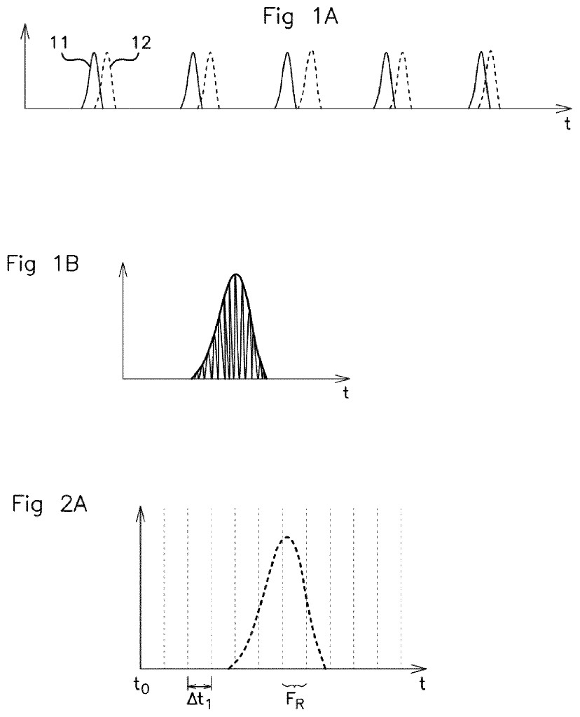

Hereinafter, reference is made simply to a transmitted pulse signal and a return pulse signal. In FIG. 1A, the curve 11, shown in an unbroken line, represents the intensity of the transmitted pulse signal as a function of time t. The curve 12, shown in dashed lines, represents the intensity of the return pulse signal as a function of time t.

FIG. 1B illustrates one of the pulses of the transmitted pulse signal in more detail. Each pulse is defined by a carrier and an envelope. The frequency of the carrier, f₂, belongs to the radiofrequency spectrum. For example, the frequency of the carrier is equal to 7.8 GHz. The envelope is defined by a frequency spectrum, the highest value of which, f₁, is far less than f₂. For example, f₁ is less than or equal to f₂/10. For example, f₁ is equal to 500 MHz.

Preferably, the transmitted pulse signal is a signal modulated using the modulation technique known as “UWB”, for “ultra wideband”. This modulation technique is based on the transmission of pulses of very short duration, preferably less than one nanosecond, and on a wide frequency spectrum.

In the same way, the return pulse signal consists of pulses each defined by a carrier of frequency f₂ and an envelope of higher frequency f₁.

The method according to an aspect of the invention comprises the following steps:
a) determining the value of an approximate distance to the target, Dₐₚ;
b) determining the value of an additional distance to the target, D_{c};
c) combining Dₐₚ and D_{c} so as to obtain an estimated value Vₑₛₜ of distance to the target; and
d) determining a series of estimated values Vₑₛₜ of distance to the target, by repeating steps a) to c).

Step a) is based on measuring a time offset between a pulse of the return pulse signal and the corresponding pulse of the transmitted pulse signal. In particular, the time offset between the respective amplitude maxima of these two pulses is measured.

In particular, this involves measuring an offset between a reception time t_{R} and a transmission time t₀, where:
t₀ is the time of transmission, by the abovementioned transceiver device, of a given pulse of the transmitted pulse signal; and
t_{R} is the time of reception, by said transceiver device, of the corresponding pulse of the return pulse signal.

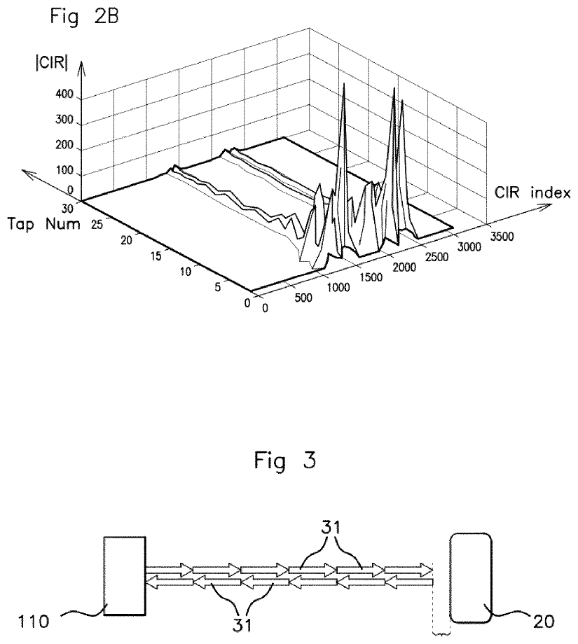

Step a) uses the return pulse signal, after it has been temporally sampled by an analog-to-digital converter, within the transceiver device. FIG. 2A schematically shows a pulse of the return pulse signal, which pulse is sampled temporally.

The sampling frequency of the return pulse signal is denoted f_{ech}. According to the Shannon criterion, the maximum value able to be adopted by f_{ech} is equal to twice f₂ (highest frequency of the envelope of the return pulse signal, considered to be equal to the highest frequency of the transmitted pulse signal). Here, for example, f₁₌₅₀₀ MHz, that is to say f_{ech}=1 GHZ.

f_{ech} sets the width Δt₁ of sampling time windows associated with the temporal sampling of the return pulse signal. In particular, Δt₁=1/f_{ech}.

Δt₁ corresponds to a margin of error on the determination of the time offset between a pulse of the return pulse signal and the corresponding pulse of the transmitted pulse signal.

The time and distance values are linked together by the value c of the speed of light in a vacuum. The time offset between a pulse of the return pulse signal and the corresponding pulse of the transmitted pulse signal is thus associated with a spatial offset between the transceiver device and the target. This spatial offset defines the value of the approximate distance Dₐₚ. The margin of error Δt₁ on the determination of the time offset is therefore associated with a margin of error Δd₁ on the determination of the approximate distance Dₐₚ. In particular, Δd₁ satisfies Δdₐ=C/f_{ech}. This therefore gives Δd₁˜15 cm.

Thus, the approximate distance Dₐₚ in step a) corresponds to the current distance between the transceiver device and the target, with a margin of error Δd₁. The following have been identified in FIG. 2A:
the time t₀ of transmission of a given pulse of the transmitted pulse signal; and
the time window F_{R} receiving the corresponding pulse of the return pulse signal.

The time t₀ may be defined from a starting time of the transmission of the pulses and a repetition frequency of the pulses.

As a variant, to may be defined from a time of reception, by the transceiver device, of a very high-intensity signal. This very high-intensity signal corresponds to part of the transmitted pulse that is detected directly by the transceiver device, without first having been reflected by the target.

Step a) may be implemented on the basis of data in the form of a matrix. Such a matrix is illustrated in FIG. 2B. It is defined by:
a first dimension, known as CIR index, corresponding to the count of the pulses of the transmitted pulse signal, wherein each transmission of a new pulse increments the value of the CIR index by one unit;
a second dimension, known as “tap num”, corresponding, for each CIR index, to the time axis divided into sampling windows;
a third dimension, called |CIR|, corresponding to the absolute value of the amplitude of the signal measured by the transceiver device, where applicable after application of at least one filtering operation to eliminate noise.

The signal measured by the transceiver device may comprise the return pulse signal and also the very high-intensity signal as mentioned above.

The first and second dimensions together correspond to folding of the time axis, so as to define a new time origin upon each new transmission of a pulse of the transmitted pulse signal. This folding of the time axis makes it possible to obtain the desired time offset directly by identifying the time window receiving an amplitude peak of the signal.

A description is given next of the physical principle defining the additional distance to the target, in the method according to an aspect of the invention.

FIG. 3 schematically illustrates the abovementioned transceiver device 110 and the target 20.

The phase of a pulse of the return pulse signal, at the transceiver device 110, comprises a high-frequency component and a low-frequency component. The high-frequency component is influenced by the speed of the target 20 (Doppler effect). The low-frequency component is influenced by the distance between the transceiver device 110 and the target 20. In an aspect of the invention, what is of more particular interest is the low-frequency component of the phase.

This low-frequency component varies continuously as the pulse 31 moves from the transceiver device 110 to the target 20, and then from the target 20 to the transceiver device 110. Each time the pulse moves by a distance λ₂, the low-frequency component of its phase varies by 2π, where λ₂ is the wavelength of a pulse of the transmitted pulse signal (related to the frequency of its carrier).

Step b) implements monitoring of phase shift values between the return pulse signal and the transmitted pulse signal. This monitoring makes it possible to count a number of increments of 2π on this phase shift, each increment of 2π corresponding to a variation of Δd₂=λ₂/2=c/(2*f₂) on the value of the additional distance to the target. This monitoring therefore makes it possible to track the evolution of a value of the additional distance to the target. In particular, the value of the additional distance to the target is modified by Δd₂ each time a phase variation of 2π is identified.

The additional distance to the target is thus determined, with a margin of error equal to Δd₂=c/(2*f₂). For example, f_{2=7.8} GHZ, that is to say Δd₂˜1.9 cm.

It will be considered that the additional distance to the target adopts the value zero at a time when the approximate distance Dₐₚ changes value. A point of origin is thus set, starting from which the additional distance to the target is defined.

It should be noted that each pulse of the transmitted pulse signal relates to a phase shift value. Multiple successive pulses are therefore necessary before being able to identify a phase shift of 2π.

The method then comprises a step c) of combining the value determined in step a) with the value determined in step b), so as to obtain an estimated value of distance to the target.

Each iteration of steps a) to c) makes it possible to determine a value of distance to the target. Steps a) to c) are repeated multiple times, in such a way as to determine a series of values of distance to the target that together define a movement of the target.

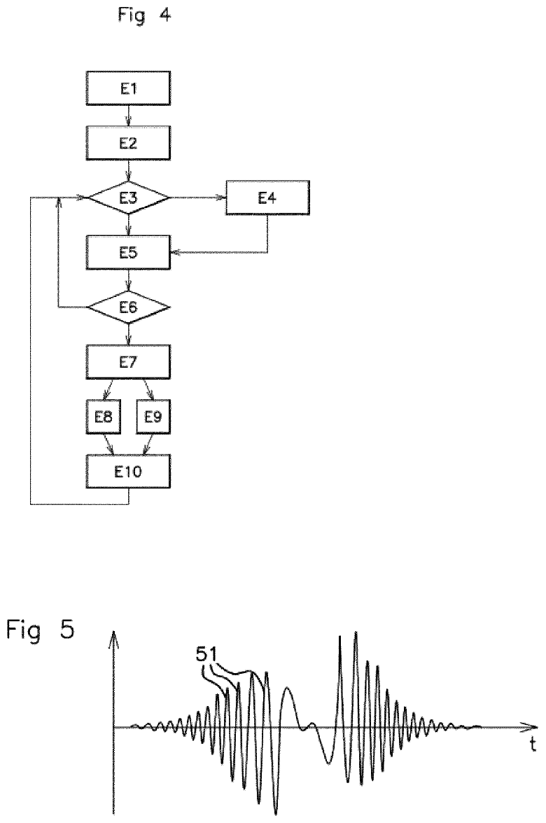

A description is given next, with reference to FIG. 4, of one advantageous embodiment of the method according to an aspect of the invention. The method of FIG. 4 comprises the steps described below, implemented by a microcontroller, and for each of a plurality of pulses of the transmitted pulse signal.

### Step E1:

The microcontroller acquires data relating to the pulse under consideration of the transmitted pulse signal, and data relating to the corresponding pulse of the return pulse signal. These data are advantageously delivered by a radar chip, which comprises at least an electronic oscillator, a radiofrequency transceiver antenna, and a signal processing module.

Preferably, said data comprise:
data relating to an in-phase mixed signal, I(t), corresponding to the return pulse signal mixed with the carrier of the transmitted pulse signal (or with the transmitted pulse signal itself); and
data relating to a phase-quadrature mixed signal, Q(t), corresponding to the return pulse signal mixed with the carrier of the transmitted pulse signal phase-shifted by π/2 (or with the transmitted pulse signal itself phase-shifted by π/2).

The signals I(t) and Q(t) are advantageously formed at the signal processing module, in the radar chip.

### Step E2:

The microcontroller uses the acquired data to determine a current value of a time offset between a time of transmission of the pulse under consideration of the transmitted pulse signal and a time of reception of the corresponding pulse of the return pulse signal.

This time offset defines a current value of the approximate distance to the target, the concepts of time and distance being related.

Preferably, the microcontroller uses said acquired data in the form of a signal relating to the amplitude of the return pulse signal, in terms of absolute value. The absolute value of the amplitude of the return pulse signal is defined by the square root of I²(t)+Q²(t).

Step E2 comprises identifying a sampling time window associated with a signal amplitude greater than or equal to a predetermined threshold.

Advantageously, step E2 is implemented using a matrix as described above, in which the time axis is folded. The identified sampling time window thus directly defines the sought time offset.

### Step E3:

The microcontroller compares the current value of the time offset, determined in step E2, with a reference time offset (preferably stored in a memory of the microcontroller).

In other words, the microcontroller compares the current value of approximate distance to the target with an approximate reference distance.

### Step E4:

If said current value of the time offset is different from the reference time offset, the microcontroller updates the value of the reference time offset, so as to set it to said current value. Furthermore, the microcontroller updates a current value of the additional distance to the target, so as to set it to the value zero.

The method may use a period counter to count a number of local maxima on monitoring of phase shift values (see below). In this case, the microcontroller also updates a current value of the period counter, so as to set it to the value zero.

### Step E5:

Step E5 is implemented after step E4, or directly after step E3 if the current value of the time offset obtained in step E2 is equal to the reference time offset.

In step E5, the microcontroller calculates the current value of the low-frequency component of a phase difference between the pulse under consideration of the transmitted pulse signal and the corresponding pulse of the return pulse signal.

Said current value of the low-frequency phase-offset component is calculated from the values of I(t) and Q(t), at a time t_{I} of the sampling time window identified in step E2. t_{I} preferably corresponds to the time at which said sampling time window begins. Where applicable, the respective derivatives of I(t) and Q(t) may be used instead, so as to eliminate offsets or continuous shifts.

In particular:

$$φ ( {t}_{1} ) = arctan ( Q ( {t}_{1} ) / I ( {t}_{1} ) ) = Φ ( {t}_{1} ) + f ( {t}_{1} ) , \qquad [ Maths 3 ]$$

where φ(t_{I}) is the total phase shift at the time t_{I},
f(t_{I}) is a high-frequency component of this phase shift, which depends on the speed of movement of the target, and
φ(t_{I}) is the sought low-frequency component.

Said current value of the low-frequency phase-shift component, φ(t_{I}), is stored in a memory of the microcontroller, and supplements phase shift value monitoring data.

The arctan function varies from −π/2 to +π/2, meaning that there may be uncertainty regarding the value of φ(t). This uncertainty may be removed by determining, from the sign of I(t) and the sign of Q(t), the quarter of the trigonometric circle in which φ(t) is located (I(t) corresponding to a real part of the phase, and Q(t) corresponding to an imaginary part of the phase).

### Step E6:

The microcontroller searches, in said phase shift value monitoring data, for the presence of a new local maximum.

To this end, the microcontroller may compare a total number of local maxima in said data with a previous count of this number of maxima. To this end, the microcontroller may use a period counter as defined above.

Each local maximum corresponds to a phase shift of 2π on the value of φ(t). Thus, as explained above, the detection of a new local maximum corresponds to a variation in the real distance to the target, by a value equal to Δd₂ in terms of absolute value, where Δd₂=C/(2*f₂) and f₂ is the frequency of the carrier of the pulses.

FIG. 5 shows a curve showing the evolution of φ(t) as a function of time. On this curve, each local maximum 51 corresponds to a variation in distance equal to Δd₂ in terms of absolute value.

If the occurrence of a new local maximum is not detected, a current value of the additional distance to the target, stored in a memory of the microcontroller, remains unchanged.

### Step E7:

If the occurrence of a new local maximum is detected, this is because the target has moved by Δd₂ in terms of absolute value. The microcontroller then determines the direction of this movement.

This determination may be based on a fast Fourier transform, so as to determine the sign of the Doppler frequency in the high-frequency component of the phase shift.

As a variant, this determination may implement a search for that one of the signals I(t) and Q(t) that forms a new local maximum first.

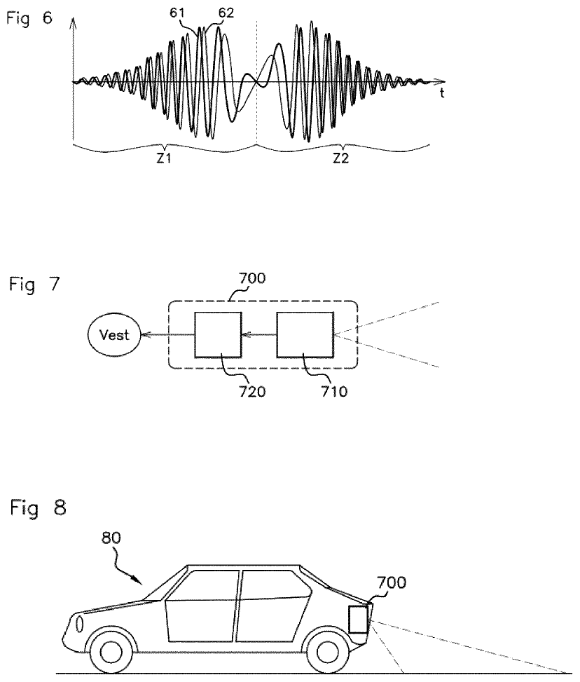

FIG. 6 illustrates a curve 61 representing the signal I(t) as a function of time (here the derivative of the signal I(t), to eliminate offsets), and a curve 62 representing the signal Q(t) as a function of time (here the derivative of the signal Q(t), to eliminate offsets).

In a zone Z1, the phase of the signal Q(t) leads that of the signal I(t), this corresponding to a target approaching the transceiver device (positive direction of movement).

In a zone Z2, the phase of the signal I(t) leads that of the signal Q(t), this corresponding to a target moving away from the transceiver device (negative direction of movement).

### Step E8:

If the direction of movement of the target is negative (target moving away), the current value of the additional distance to the target is increased by Δd₂.

### Step E9

If the direction of movement of the target is positive (target approaching), the current value of the additional distance to the target is reduced by Δd₂.

### Step E10:

After step E8, respectively E9, or after step E6 if the occurrence of a new local maximum is not detected, the microcontroller adds the current value of approximate distance to the target, determined in step E2, to the current value of the additional distance to the target, determined in step E8, respectively E9, respectively E6. The result of this addition forms an estimated value of distance to the target.

Steps E1 to E10 are implemented multiple times, so as to determine a series of estimated values of distance to the target, together defining a movement performed by the target.

An aspect of the invention also covers a microcontroller configured to implement the steps of a method according to an aspect of the invention. Such a microcontroller comprises:
input and output interfaces, configured such that the microcontroller receives, at input, data relating to the transmitted pulse signal and to the return pulse signal (advantageously in the form of signals I(t) and Q(t) as defined above) and delivers, at output, estimated values of distance to the target,
at least one processor, and
at least one memory, storing a computer program product comprising instructions that, when the program is executed by the at least one processor, cause said processor to implement the method according to an aspect of the invention.

The at least one memory also stores data such as a current value of the approximate distance to the target, a current value of the additional distance to the target, and a reference time offset.

FIG. 7 schematically illustrates a motion detection system 700 according to an aspect of the invention. The system 700 comprises:
a transceiver device 710, configured to transmit the transmitted pulse signal and to receive the return pulse signal; and
a signal processing module 720, connected to the transceiver device, and comprising at least a microcontroller according to an aspect of the invention.

The transceiver device 710 comprises at least a radiofrequency antenna.

Preferably, the signal processing module 720 is configured to receive, at input, data relating to the transmitted pulse signal and data relating to the return pulse signal, and to implement a first processing operation in order to obtain the signals I(t) and Q(t) defined above.

The signal processing module 720 is furthermore configured to implement a second processing operation, using the signals I(t) and Q(t) to provide estimated values Vₑₛₜ of distance to the target.

The first processing operation may be implemented within a first microcontroller, belonging to a radar chip that also comprises the transceiver device 710.

The second processing operation may be implemented within a microcontroller according to an aspect of the invention, distinct from said first microcontroller. The microcontroller according to an aspect of the invention may be integrated close to the radar chip, within a motor vehicle. As a variant, the microcontroller according to an aspect of the invention may be remote from the radar chip, and belong to a motor vehicle central control unit. According to yet other variants, the first processing operation and the second processing operation are implemented by a single microcontroller.

FIG. 8 schematically illustrates a motor vehicle 80 equipped with the motion detection system 700.

An aspect of the invention is advantageously implemented within a motor vehicle, so as to detect a predetermined movement performed by a user, said movement being intended to control opening of an opening element of the vehicle. The opening element is for example, but without limitation, the opening element of the rear trunk, or a side door. The predetermined movement is for example a swinging of the foot.

The pulses under consideration may be formed by the concatenation of elementary pulses belonging to one and the same frame.

1. A gesture detection method implemented within a motor vehicle so as to detect a predetermined gesture performed by a user, said gesture being intended to control the opening of an opening element of the motor vehicle, the method using a return pulse signal resulting from the reflection of a transmitted pulse signal from a target, the return pulse signal and the transmitted pulse signal each consisting of radiofrequency pulses, the method comprising:
a) determining an approximate distance to the target, implementing measurement of a time offset between a pulse of the return pulse signal and the corresponding pulse of the transmitted pulse signal;
b) determining an additional distance to the target, implementing monitoring of phase shift values between the return pulse signal and the transmitted pulse signal;
c) combining the approximate distance to the target and the additional distance to the target, so as to obtain an estimated value of distance to the target; and
d) repeating steps a) to c), so as to obtain a series of estimated values of distance to the target, said series of values defining a gesture performed by the user.

2. The method as claimed in claim 1, wherein step a) comprises identifying, on a temporally sampled amplitude signal, a sampling time window receiving a local maximum of said amplitude signal.

3. The method as claimed in claim 1, wherein, in step b), the phase shift values each consist of a low-frequency component of a phase shift between the return pulse signal and the transmitted pulse signal.

4. The method as claimed in claim 1, wherein, in step b), the phase shift values each relate to a predetermined time belonging to a sampling time window identified in step a).

5. The method as claimed in claim 1, wherein, in step b), determining an additional distance to the target implements:
detection of at least one local maximum, on data relating to the monitoring of phase shift values between the return pulse signal and the transmitted pulse signal; and
when a new local maximum is detected, updating of a current value of the additional distance to the target, so as to vary it by an elementary target offset value.

6. The method as claimed in claim 5, wherein said updating comprises determining a direction of movement of the target, so as to determine whether the updating consists in adding or subtracting the elementary target offset value.

7. The method as claimed in claim 6, wherein determining the direction of movement of the target implements a search for the signal the phase of which leads that of the other, out of the return pulse signal mixed with the transmitted pulse signal or its carrier, and the return pulse signal mixed with the transmitted pulse signal phase-shifted by an angle of 90° or its carrier phase-shifted by an angle of 90°.

8. The method as claimed in claim 5, wherein determining the additional distance to the target implements resetting of the current value of the additional distance to the target to the value zero when a variation in the time offset between a pulse of the return pulse signal and the corresponding pulse of the transmitted pulse signal was detected in step a).

9. The method as claimed in claim 1, wherein steps a) to c) are implemented by implementing the following steps, for each of a plurality of pulses of the transmitted pulse signal:
i) determining a time offset between said pulse of the transmitted pulse signal and the corresponding pulse of the return pulse signal, this time offset defining the value of the approximate distance to the target;
ii) comparing between the time offset determined in step i) and a reference time offset;
iii) when the time offset determined in step i) is different from the reference time offset, updating the value of the reference time offset so as to set it to the value determined in step i), and setting the additional distance to the target to the value zero;
iv) calculating a value of a phase shift between said pulse of the transmitted pulse signal and the corresponding pulse of the return pulse signal, and using said phase shift value to supplement phase shift value monitoring data;
v) searching for a new local maximum in said monitoring data;
vi) when a new local maximum is detected, determining a direction of movement of the target, and updating the value of the additional distance to the target so as to increase it or reduce it-depending on the direction of movement of the target;
vii) summing (E10) the approximate distance to the target and the additional distance to the target, so as to obtain the estimated value of the distance to the target.

10. The method as claimed in claim 1, further comprising:
comparing said series of values with data defining a predetermined gesture, so as to detect when said predetermined gesture has been performed by the user; and
formulating a command to open the opening element of the motor vehicle when said predetermined gesture has been detected.

11. A non-transitory computer program product comprising instructions that, when the program is executed by a processor, cause said processor to implement the method as claimed in claim 1.

12. A microcontroller intended to be installed within a motor vehicle (80), comprising at least one processor and at least one memory, and configured to implement the steps of the method as claimed in claim 1, the microcontroller being configured to receive, at input, data relating to the return pulse signal and data relating to the transmitted pulse signal, and the microcontroller being configured to deliver, at output, said series of estimated values of the distance to the target, said series of values defining a gesture performed by a user of the motor vehicle.

13. A gesture detection system, configured to be installed in a motor vehicle, and comprising:
a transceiver device, configured to transmit said transmitted pulse signal and to receive said return pulse signal; and
a signal processing module, connected to the transceiver device, and comprising a microcontroller as claimed in claim 11.

14. A system for controlling the opening of a motor vehicle opening element, comprising a gesture detection system as claimed in claim 13, and also a computer configured to:
receive, at input, said series of values defining a gesture performed by a user of the motor vehicle;
compare said series of values with data defining a predetermined gesture, so as to detect when said predetermined gesture has been performed by the user; and
formulate a command to open the opening element of the motor vehicle, when said predetermined gesture has been detected, and deliver, at output, said command for transmission to a system for controlling the opening of the opening element of the motor vehicle.

15. A motor vehicle equipped with a gesture detection system as claimed in claim 13.

16. The method as claimed in claim 2, wherein, in step b), the phase shift values each consist of a low-frequency component of a phase shift between the return pulse signal and the transmitted pulse signal.

17. The method as claimed in claim 2, wherein, in step b), the phase shift values each relate to a predetermined time belonging to a sampling time window identified in step a).

18. The method as claimed in claim 6, wherein determining the additional distance to the target implements resetting of the current value of the additional distance to the target to the value zero when a variation in the time offset between a pulse of the return pulse signal and the corresponding pulse of the transmitted pulse signal was detected in step a).
